(19) United States
(12) Patent Application Publication
(10) Pub. No.: US 2025/0149627 A1
(43) Pub. Date: May 8, 2025

(54) SOLID STATE BATTERY, CERAMIC ELECTROLYTE STRUCTURE, AND METHODS OF MAKING

(71) Applicant: GE Infrastructure Technology LLC, Greenville, SC (US)

(72) Inventors: Joseph J. SHIANG, Niskayuna, NY (US); Anil Raj DUGGAL, Niskayuna, NY (US); Hongyi ZHOU, Niskayuna, NY (US); Hongbo CAO, Cohoes, NY (US); Kevin Henry JANORA, Schenectady, NY (US); Richard Louis HART, Broadalbin, NY (US)

(21) Appl. No.: 18/837,007

(22) PCT Filed: Feb. 10, 2023
(86) PCT No.: PCT/US2023/062363

§ 371 Date: Aug. 8, 2024

Related U.S. Application Data
(60) Provisional application No. 63/309,103, filed on Feb. 11, 2022.

(51) Int. Cl. H01M 10/0562; H01M 10/052; H01M 10/42

(52) U.S. Cl. CPC H01M 10/0562; H01M 10/052; H01M 10/4235; H01M 2300/0071; H01M 2300/0094

(57) ABSTRACT

A porous electrolyte structure for a solid state battery is provided. The porous electrolyte structure includes an inter-metallic layer disposed on a surface and has an interconnected ceramic matrix with a network of open pores disposed throughout a thickness of the porous electrolyte structure. The porous electrolyte structure includes a porosity of about 10% by volume to about 80% by volume. A solid state battery cell including the porous electrolyte structure and a method of making the solid state battery cell are also provided.

### CROSS REFERENCE TO RELATED APPLICATIONS

This application claims the priority benefit of U.S. Provisional Patent Application Ser. No. 63/309,103 filed Feb. 11, 2022. the entirety of which is incorporated by reference in its entirety.

### STATEMENT ON FEDERALLY SPONSORED RESEARCH AND DEVELOPMENT

This invention was made with government support under contract number HR001122C009 awarded by the U.S. Defense Advanced Research Projects Agency (DARPA). The government has certain rights in the invention.

### BACKGROUND

The field of the disclosure relates to solid state batteries and more particularly, to solid state batteries with porous ceramic electrolyte structures.

Rechargeable lithium ion batteries have a high energy density and are a good energy storage system for a wide range of applications. However, lithium ion batteries have a flammable liquid electrolyte, which can cause the battery to ignite or explode if there is leakage of the electrolyte.

Lithium metal batteries have a higher theoretical capacity than conventional lithium ion batteries with a graphite-based anode: however, as a lithium metal anode is not chemically compatible with most liquid electrolytes, a solid state electrolyte is used.

Solid state electrolytes (SSEs), such as ceramic-based electrolytes, are a desirable alternative for use in a lithium metal battery system. They provide greater safety, as the electrolyte is a non-flammable solid and will not ignite, and have the potential to provide high energy density at a lower cost.

However, most ceramic-based SSEs only work in batteries under low current densities, which generally result in long charge times. At higher current densities, a fully ceramic battery undergoes fatigue and fracture, due to volume changes in the electrodes, particularly, in the anode, as lithium is deposited and stripped during battery cycling. In addition, there are often small gaps between the solid electrolyte and current collector, which can cause a loss of interfacial contact and lead to a rise in battery electric resistance and to a loss of charge capacity. These gaps can also create a stress concentration that is associated with the formation of lithium dendrites. As lithium-metal dendrites form, they penetrate through the solid ceramic electrolyte and may eventually cause an electrical short, which renders the battery inoperable. Void formations can form during discharge leading to stranded lithium.

A typical solid state battery (SSB) is formed of a thick dense ceramic-based electrolyte. The ceramic-based SSE is manufactured separately and sintered to provide full density or close to full density with no porosity before being added to the battery as an input material. The thickness of the SSE is dictated by the need to maintain structural integrity during the manufacturing process and is generally greater than 100 micrometers. The relatively large thickness of the SSE reduces the energy density of the battery and separate processing of the SSE adds to manufacturing costs.

Accordingly, an improved ceramic-based solid state electrolyte and battery with a reduced tendency for void formations and for dendrites to form is desirable. Further, an improved solid state battery with increased energy and power density for optimal performance, and an improved process for making solid state batteries having a ceramic-based solid electrolyte with reduced manufacturing costs are also desirable.

### BRIEF DESCRIPTION

The present disclosure overcomes the problems inherent in the art and provides an improved ceramic-based solid electrolyte structure for a solid state battery with increased safety that can reduce metal dendrite formation and detrimental void formation and provide a solid state battery with higher energy density and power capabilities.

In one aspect, a solid state battery cell includes a porous electrolyte structure and an intermetallic layer disposed on the porous electrolyte structure. The porous electrolyte structure has a thickness and an interconnected ceramic matrix with a network of open pores disposed throughout the thickness of the porous electrolyte structure. The porous electrolyte structure includes a porosity of about 10% by volume to about 80% by volume.

In another aspect, a solid state battery cell includes a cathode, an anode and a porous electrolyte structure disposed between the cathode and the anode and an intermetallic layer disposed on the porous electrolyte structure. The porous electrolyte structure has a thickness and an interconnected ceramic matrix with a network of open pores disposed throughout the thickness of the porous electrolyte structure. The porous electrolyte structure includes a porosity of about 10% by volume to about 80% by volume.

In another aspect, a porous electrolyte structure for a solid state battery is provided. The porous electrolyte structure includes an intermetallic layer disposed on a surface and having a thickness and an interconnected ceramic matrix with a network of open pores disposed throughout the thickness of the porous electrolyte structure. The porous electrolyte structure includes a porosity of about 10% by volume to about 80% by volume.

In yet another aspect, a method for producing a solid state battery cell is provided. The method includes forming a porous electrolyte structure having a thickness and an interconnected ceramic matrix with a network of open pores disposed throughout the thickness of the porous electrolyte structure, applying an intermetallic layer on a surface of the porous electrolyte structure, and inserting the porous electrolyte structure between an anode and a cathode. The porous electrolyte structure includes a porosity of about 10% by volume to about 80% by volume, based on the volume of the porous electrolyte structure.

The various aspects of the disclosure provide improved solid state electrolytes and low weight batteries with high safety and increased energy and power capabilities.

### BRIEF DESCRIPTION OF THE DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1A is a schematic drawing of a conventional solid state battery in a charged state.

FIG. 1B is a schematic drawing of a conventional solid state battery in a discharged state.

FIG. 2 is a schematic drawing of a portion of a conventional solid state battery where a lithium dendrite is formed and leads to crack formation in solid state electrolyte.

FIG. 3A is a schematic diagram of a solid state battery cell in a charged state in accordance with an aspect of the disclosure.

FIG. 3B is a schematic diagram of a solid state battery cell in a discharged state in accordance with an aspect of the disclosure.

FIG. 4 is a microscopy image from a scanning electron microscope depicting a fracture of a coated porous electrolyte structure in accordance with an aspect of the disclosure.

FIG. 5 is an Energy Dispersive X-Ray Spectroscopic map of the platinum coating in a thickness of the LLZO electrolyte structure in accordance with an aspect of the disclosure.

FIG. 6A is a schematic diagram of a coin cell assembly in accordance with an aspect of the disclosure.

FIG. 6B is a microscopy image from a scanning electron microscope depicting a view of the coated ceramic matrix in accordance with an aspect of the disclosure.

FIG. 7 is a graph of Capacity (mAh) vs. Voltage (V) showing the first charge cycle of the exemplary coin cell batteries and control described in Example 2.

FIG. 8 is a graph of cycle vs. Energy (Wh) entitled Energy Discharged versus cycle.

### DETAILED DESCRIPTION

The following detailed description and examples set forth example materials and procedures used in accordance with the present disclosure. It is to be understood, however, that this description and these examples are provided by way of illustration only, and nothing therein shall be deemed to be a limitation upon the overall scope of the present disclosure.

The singular forms “a”, “an” and “the” include plural referents unless the context clearly dictates otherwise. The endpoints of all ranges reciting the same characteristic are independently combinable and inclusive of the recited endpoint. All references are incorporated herein by reference.

The modifier “about” used in connection with a quantity is inclusive of the stated value and has the meaning dictated by the context (e.g., includes the tolerance ranges associated with measurement of the particular quantity). Where ranges are disclosed, the endpoints of all ranges directed to the same component or property are inclusive, independently combinable and include all intermediate values of the ranges.

“Optional” or “optionally” means that the subsequently described event or circumstance may or may not occur, or that the subsequently identified material may or may not be present, and that the description includes instances where the event or circumstance occurs or where the material is present, and instances where the event or circumstance does not occur or the material is not present.

Terms “first”. “second”, and the like, as used herein do not denote any order. quantity or importance, but rather are used to distinguish one element from another. Also, the terms “front”, “back”, “bottom” and/or “top”, unless otherwise noted, are merely used for convenience of description, and are not limited to any one position or spatial orientation.

Unless noted otherwise, all porosity measurements provided for the electrolyte structure are based on the volume of the porous electrolyte structure. The term “porosity” by volume used herein refers to a value estimated by measuring the density of the porous electrolyte structure (ρ) and comparing it with the density of a 100% dense electrolyte structure based on the theoretical density (ρd) of the same solid electrolyte material according to equation 1. [eq. 1: Porosity=1−ρ/ρd]. Porosity may also be measured experimentally by porometry.

The various aspects of the disclosure provide improved ceramic solid state electrolytes and low weight lithium solid state batteries with ceramic solid state electrolytes having higher current densities and power capabilities with reduced dendrite and void formations, high energy density, increased safety, and reduced cost. These batteries exhibit persistent performance at long cycle time.

Structural changes occur in lithium-metal anodes as lithium is cycled and lithium is shuttled from one side to the other in response to an applied potential or load. Li-dendrite formation can occur upon charging and void formation can occur upon discharge leading to stranded lithium, loss of interfacial contact and subsequent loss of charge capacity.

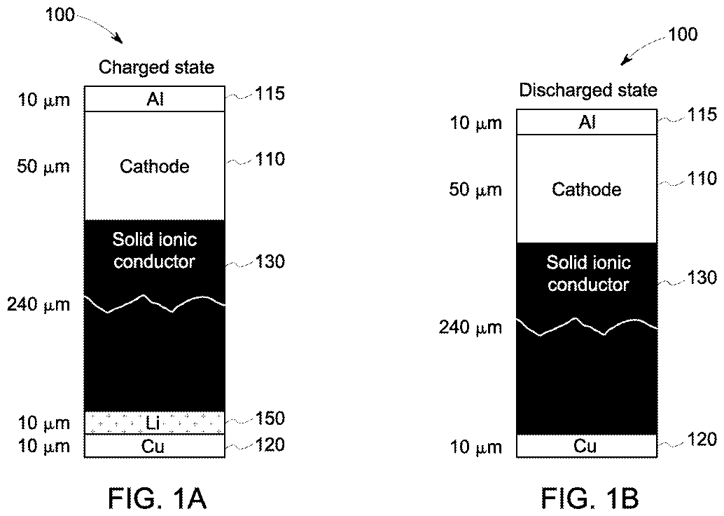

In a conventional solid state battery cell, the solid electrolyte structure is formed from a dense ceramic material and is depicted in FIGS. 1A and 1B. FIGS. 1A and 1B show a conventional battery cell 100 having a cathode 110 with a thickness of about 50 micrometers, an aluminum current collector 115 having a thickness of about 10 micrometers, an anode 120 having a copper current collector and having a thickness of about 10 micrometers, and a solid ionic conductor or solid electrolyte 130 prepared from a dense ceramic material and having a thickness of about 240 micrometers. FIG. 1A depicts the solid state battery cell in a charged state and FIG. 1B depicts the solid state battery cell in a discharged state. As the battery charges, positive ions, such as lithium ions, move toward the anode and deposit a layer 150 of lithium metal on the anode 120. This added layer 150 of lithium metal creates a volume change within the battery cell during battery charging. The thickness of the battery in the discharged state shown in FIG. 1B is 310 micrometers; while the thickness of the battery in the charged state increases to about 320 micrometers due to the added layer 150 of lithium metal deposited on the anode (about 10 micrometers). Volume changes within a solid state battery cell result in stress within the cell. Uneven lithium deposition in layer 150 between solid electrolyte 130 and anode 120 is associated with lithium dendrite formation in ceramic electrolytes during high current density charging.

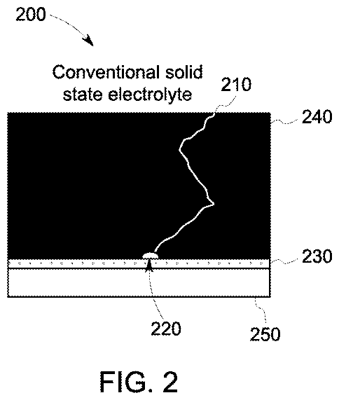

Stress may build along the interface between the anode 120 and the dense ceramic electrolyte as the lithium ions are reduced and deposited on the anode 120 during charging and as the layer 150 of lithium metal begins to push the anode 150 away from the dense ceramic electrolyte. Where there is an imperfection on the interface between the electrode and electrolyte, a stress concentration is created as lithium metal deposit is formed at the site of the imperfection. Eventually, a crack in the electrolyte develops due to stress build up from continued lithium deposition and cracks the solid electrolyte, allowing the lithium metal to enter and form a dendrite. FIG. 2 depicts a conventional solid state battery cell 200 where a lithium dendrite 210 has formed at an imperfection 220 on an interface 230 between a dense ceramic electrolyte 240 and an anode 250.

In a first aspect, a solid state battery cell includes a porous electrolyte structure and an intermetallic layer disposed on the porous electrolyte structure. The porous electrolyte structure has a thickness and an interconnected ceramic matrix with a network of open pores disposed throughout the thickness of the porous electrolyte structure. The porous electrolyte structure includes a porosity of about 10% by volume to about 80% by volume.

A solid state battery cell includes an anode or negative electrode, a cathode or positive electrode and a solid electrolyte structure or solid ionic conductor situated between the electrodes for conducting ions between the cathode and anode. In one aspect, the solid electrolyte structure is a ceramic material and is configured to move ions, such as lithium or sodium ions, while resisting the flow of electrons, which allows electrons to move outside the battery.

In one aspect, the solid electrolyte structure is porous with an interconnected ceramic matrix and a network of open pores disposed throughout the solid electrolyte. The porous structure includes a plurality of open pores extending from the surface and disposed throughout the thickness of the solid state electrolyte. In one aspect, the ceramic matrix and the open pore network are continuous, forming two interpenetrating continua.

The porous electrolyte structure has a thickness and an interconnected ceramic matrix with a network of open pores disposed throughout the thickness of the porous electrolyte structure. In one aspect, the porous electrolyte structure has a porosity of about 10% by volume to about 80% by volume. In another aspect, the porous electrolyte has a porosity of about 20% by volume to about 80% by volume. In another aspect, the porous electrolyte has a porosity of about 20% by volume to about 70% by volume. In another aspect, the porosity may be about 30% by volume to about 80% by volume and in another aspect, the porosity may be from about 30% by volume to about 70% by volume. In another aspect. the porosity is 30% by volume to about 60% by volume, based on the volume of the porous electrolyte structure. In another aspect, the porosity may be about 50% by volume to about 80% by volume and in another aspect, the porosity may be from about 50% by volume to about 70% by volume. In another aspect, the porosity is from about 50% by volume to about 60% by volume. In one aspect, the electrolyte structure has a porosity greater than 20% by volume. In one aspect, the electrolyte structure has a porosity of at least 30% by volume. In another aspect, the electrolyte structure has a porosity of at least 50% by volume.

The pores or void spaces may be uniform in size and shape or irregularly formed. In one aspect, the pores have an average pore diameter from about 50 nm to about 500 μm. In another aspect, the pores have an average pore diameter ranging from about 100 nm to about 500 μm. In another aspect, the pores have an average pore diameter from about 50 nm to about 500 nm.

In one aspect, the porous electrolyte structure includes a ceramic electrolyte material. The ceramic material may be any ceramic material having low electronic conductivity with a high ionic transference number, high ionic conductivity, mechanical strength, temperature stability and which is electrochemically stable with the electrode materials. In one aspect, the ceramic material has an ionic conductivity of above 10⁻⁴ S/cm at room temperature. In one aspect, the ceramic material includes, but is not limited to, NASICON-type (sodium super ionic conductor), garnet-type, perovskite-type, LISICON-type (lithium super ionic conductor-type), LiPON-type (lithium phosphorus oxynitride), lithium nitride-type, sulfide-type, agryrodite-type, anti-perovskite-type or mixtures thereof.

In one aspect, the NASICON-type material may include a NASICON-type Li-ion material. In another aspect, the garnet-type material may include a lithium-containing garnet material. In another aspect, the perovskite-type material may include lithium lanthanum titanate (LLTO), lithium strontium tantalum zirconium oxide (LSTZ), lithium strontium tantalum hafnium oxide (LSTH) or lithium strontium niobium zirconium oxide (LSNZ). In one aspect, the sulfide-type material may be lithium phosphorus sulfide (LPS).

In another aspect, the NASICON-type Li-ion material has the formula LiM₂(PO₄)₃, where M is Ti or Ge. In another aspect, the NASICON-type Li-ion material may be doped with aluminum or scandium. In one aspect, the lithium-containing garnet material may be lithium lanthanum zirconium oxide (LLZO). In another aspect, the LLZO has the formula Li₇La₃Zr₂O₁₂. In another aspect, LLZO may be doped with aluminum, tantalum or gadolinium. In one aspect. LLTO has the formula Li₃₋ₓLa_{2/3-x}TiO₃, where 0<x<2/3. In another aspect, LSTZ has the formula Li_{3/8}Sr_{7/16}Ta_{3/4}Zr_{1/4}O₃. In another aspect, LSTH has the formula Li_{3/8}Sr_{7/16}Ta_{3/4}Hf_{1/4}O₃. In another aspect, LSNZ has the formula Li_{3/8}Sr_{7/16}Nb_{3/4}Hf_{1/4}Zr_{1/4}O₃. In one aspect, LISICON-type material has the formula γ-Li₃PO₄. In one aspect, the argyrodite-type material has the formula Li₆PS₅X, where X═Cl, Br or I. In another aspect, the anti-perovskite material is Li₃OX, where X═Cl, Br or I.

In one aspect, the ceramic material includes, but is not limited to: LiTi₂(PO₄)₃; LiTi₂(PO₄)₃-0.2Li₃BO₃; Li_{1.3}Al_{0.3}Ti_{1.7}(PO₄)₃; Li_{1.3}M_{0.3}Ti_{1.7}(PO₄)₃, where M is Al or Sc; 2[Li_{1.4}Ti₂Si_{0.4}P_{2.6}O₁₂]-AlPO₄; 100[Li_{1.5}Cr_{0.5}Ti_{1.5}(PO₄)₃]-5SiO₂; Li_{1.5}Al_{0.5}Ge_{1.5}(PO₄)₃; Li_{1.5}Al_{0.5}Ge_{1.5}(PO₄)₃-0.05Li₂O; 19.75Li₂O*6.17Al₂O₃*37.04GeO₂*37.04P₂O₅; Li_{1.5}Al_{0.4}Cr_{0.1}GE_{1.5}(PO₄)₃; Li₇La₃Zr₂O₁₂; Li_{6.75}La₃(Zr_{1.75}Nb_{0.25})O₁₂; Li_{7.06}La₃Y_{0.06}Zr_{1.94}O₁₂; Li_{6.4}La₃Zr_{1.4}Ta_{0.6}O₁₂; Li_{6.55}Ga_{0.15}La₃Zr₂O₁₂; Li_{6.4}Ga_{0.2}La₃Zr₂O₁₂; Li_{6.25}Ga_{0.25}La₃Zr₂O₁₂; Li_{6.20}Ga_{0.30}La_{2.95}Rb_{0.05}Zr₂O₁₂; Li_{6.65}Ga_{0.15}La₃Zr_{1.90}Sc_{0.10}O₁₂; Li_{0.35}La_{0.55}TiO₃; Li_{0.34(1)}La_{0.51(1)}TiO_{2.94(2)}; LiSr_{1.65}Zr_{1.3}Ta_{1.7}O₉; Li₁₄Zn(GeO₄)₄; Li₃₊ₓGeₓV₁₋ₓO₄, where 0<x<1; Li_{3.5}Ge_{0.5}V_{0.5}O₄; Li_{3.6}Ge_{0.6}V_{0.4}O₄; Li₄₋ₓSi₁₋ₓPₓO₄, where 0<x<1; Li_{3.5}Si_{0.5}P_{0.5}O₄; Li_{3.4}Si_{0.4}P_{0.6}O₄; Li_{10.42}Si_{1.5}P_{1.5}C_{10.08}O_{11.92}; Li_{10.42}Ge_{1.5}P_{1.5}Cl_{0.08}O_{11.92}; Li₃PO₄: Li₃*2Li₂O; Li₃N; Li₉N₂Cl₃; 3Li₃N*MI, where M=Li, Na, K, Rb; Li₄GeS₄; Li₁₀GeP₂S₁₂; Li₂S*P₂S₅; Li_{4.25+n}(Ge_{0.75-n}Ga_{0.25})S₄, where 0<n<0.75; Li_{3.25}Ge_{0.25}P_{0.75}S₄; Li₁₀GeP₂S₁₂; Li₁₀GeP₂S_{11.7}O_{0.3}; Li_{9.54}Si_{1.74}P_{1.44}S_{11.7}Cl_{0.3}; 70Li₂S-30P₂S₅ glass; 70Li₂S-30P₂S₅ glass- ceramic; 0.23B₂S₅-0.10P₂S₅-0.67Li₂S glass; 75Li₂S*25P₂S₅ glass; 75Li₂S*25P₂S₅ glass-ceramic; 80Li₂S*20P₂S₅ glass; 80Li₂S*20P₂S₅ glass-ceramic; Li₆PS₅Cl; Li₆PS₅Br; Li₆PS₅I; Li₂ₓSiP₂S₇₊ₓ where 10<x<12; Li₃OCl; Li₃OCl_{0.5}Br_{0.5}; Li_{2.99}Ba_{0.005}ClO: Li_{6.5}La₃Zr₂₋ₓAlₓO₁₂, where 0<x<1; Li_{6.5}La₃Zr₂₋ₓTaₓO₁₂, where 0<x<1; and mixtures thereof.

The solid electrolyte material may include additional materials, such as lithium borate, lithium phosphate, lithium titanium phosphate, lithium tetraborate (Li₂B₄O₇), lithium carbonate (Li₂CO₃) and eutectic flux materials, such as LiCl:KCl, SrCl₂:LiCl and CaCl₂:LiCl.

The porous ceramic solid state electrolyte structure may be manufactured with the battery cell allowing the electrolyte structure to be thinner than if it were manufactured separately and required a thicker supporting structure. In one aspect, the porous electrolyte structure has a thickness of 100 micrometers or less. In another aspect, the electrolyte structure has a thickness ranging from about 10 micrometers to about 100 micrometers. In one embodiment, the electrolyte structure has a thickness from about 10 micrometers to about 75 micrometers. In another aspect. the electrolyte structure has a thickness in a range of from about 10 micrometers to about 50 micrometers. In another aspect, the electrolyte structure has a thickness from about 10 micrometers to about 30 micrometers. In another aspect, the electrolyte structure is about 18 micrometers to 20 micrometers thick.

In one aspect, the solid state electrolyte structure includes an intermetallic layer, such as a coating or film, disposed on the interconnected ceramic matrix forming the open pore network. The intermetallic layer or coating is electrically conductive, lithium wetting, and capable of lithium atom transport. The intermetallic coating or layer includes one or more metallic alloying elements that can form a solid alloy with lithium. The lithium metal alloy may be a solid alloy including lithium and one or more metallic alloying elements. Suitable alloying elements include metallic elements or semiconductor elements of groups II, IB, IIB, III, IV and V. Examples of alloying elements include, but are not limited to aluminum, antimony, bismuth, calcium, carbon, gallium, germanium, indium, tin, magnesium, silicon, strontium, silver, gold, platinum, zinc or combinations thereof. The intermetallic layer does not react with the solid electrolyte, and will not degrade the electrolyte material over time. The intermetallic layer has a high conductivity interface with lithium metal of about 10 mS/cm.

In one embodiment, the intermetallic layer includes platinum and the platinum can alloy with lithium to produce a lithium metal alloy having the formula LiₙPt. In some embodiments, n is 4. In other embodiments, n is 9.

In another embodiment, the intermetallic layer includes a lithium metal alloy having the property that a complete electrical-chemical separation of the lithium from the alloying element has a reduction potential greater than 0.2 V positive relative to that of Li metal. The Li chemical activity of the lithium metal alloy is lower than the chemical activity for Li metal and the Li metal is hard to extract from the intermetallic layer. The additional voltage that is needed to separate the lithium from the alloying element increases the likelihood that the intermetallic layer may not be completely removed via discharge of the battery but allows for a plateau in the current voltage curve that can be used to control the discharge rate. Examples of alloying elements that exhibit this effect in a lithium metal alloy include In, Bi, Ga, Sb, Al, and Sn.

The intermetallic layer includes a lithium metal alloy and may include one or more metallic elements that do not have a large lithium solubility and do not form an alloy with the Li metal. These non-lithium-alloying metals can provide a nucleation or other structural framework for the lithium metal alloy component. Suitable non-lithium-alloying metals can be drawn from the transition metal group (groups IIIB-VIIIB,) group I, and the lanthanide series. In some aspects, the non-lithium-alloying metals may be integrated within the intermetallic layer. In other embodiments, the non-lithium-alloying metals may be applied to the surface of the intermetallic layer in any customary manner. The intermetallic layer may include conductive particles, such as carbon. In some aspects, the conductive particles are integrated within the intermetallic layer. In other embodiments, the conductive particles may be applied to the surface of the intermetallic layer in any customary manner. The metallic elements and conductive particles can aid conductivity and improve performance of the battery.

In one embodiment, the intermetallic layer includes low-melting-point eutectic alloys including gallium, indium, tin or combinations thereof, such as Ga:In:Sn. Low-melting-point eutectic alloys can provide a ‘self-healing’ cycle to partial delithiation of the intermetallic layer from the formation of a liquid flow phase. In one aspect, the intermetallic layer or coating covers the interconnected ceramic matrix of the porous electrolyte structure without closing or filling up the pore spaces. In one aspect, the intermetallic layer contacts the anode or an anode interface layer and is electrically connected to the anode. In one aspect, there is no intermetallic layer between the cathode and the solid state electrolyte. In some embodiments. the interconnected ceramic matrix is partially coated with the intermetallic layer. In some embodiments, the intermetallic layer is disposed on a portion of the interconnected ceramic matrix and a portion of the interconnected ceramic matrix does not include the intermetallic layer. In another embodiment. from about 10 percent to about 90 percent of the total extent or thickness of the ceramic matrix includes the intermetallic layer disposed thereon. In another embodiment, from about 15 percent to about 85 percent of the total extent or thickness of the ceramic matrix includes the intermetallic layer disposed thereon. In another embodiment, from about 20 percent to about 80 percent of the total extent or thickness of the ceramic matrix includes the intermetallic layer disposed thereon. In another embodiment, from about 25 percent to about 75 percent of the total extent or thickness of the ceramic matrix includes the intermetallic layer disposed thereon.

In some embodiments, the porous solid state electrolyte structure includes a coated section with the intermetallic layer disposed on the ceramic matrix and a non-coated section that does not include the intermetallic layer. In some embodiments, the interconnected ceramic matrix within the coated section is fully coated or covered by the intermetallic layer. In some embodiments, the coated section of the electrolyte structure is situated adjacent the anode section or an anode interface layer and adjacent the non-coated section of the electrolyte structure. In some embodiments, the interconnected ceramic matrix is fully coated with the intermetallic layer. In one embodiment, the coated section is from about 10 percent to about 75 percent of the total extent or thickness of the electrolyte structure. In another embodiment, the coated section is from about 15 percent to about 75 percent of the electrolyte structure. In another embodiment, the coated section is from about 20 percent to about 75 percent of the electrolyte structure. In another embodiment, the coated section is from about 25 percent to about 75 percent of the electrolyte structure. In one aspect, the porous electrolyte structure includes a coated section having a thickness from about 1 micrometer to about 75 micrometers. In another aspect, the electrolyte structure includes a coated section having a thickness from about 1 micrometer to about 40 micrometers. In another aspect, the electrolyte structure includes a coated section having a thickness from about 1 micrometer to about 20 micrometers. In another aspect, the electrolyte structure includes a coated section having a thickness from about 2 micrometers to about 15 micrometers thick.

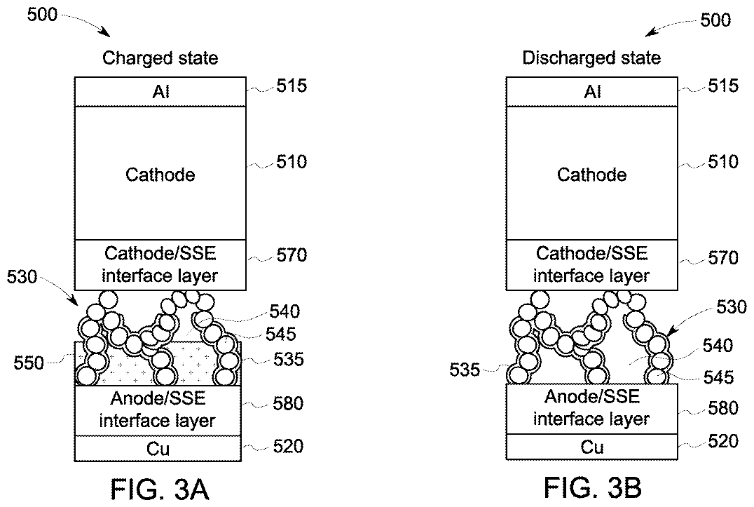

In one particular embodiment, the intermetallic layer has an electrical connection to the anode, but does not electrically contact the cathode. With reference to FIGS. 3A and 3B, one embodiment of the solid state battery cell is illustrated. FIG. 3A shows the battery in a charged state and FIG. 3B shows the battery in a discharged state. FIGS. 3A and 3B show a battery cell 500 having a cathode 510 with an aluminum current collector 515 and a cathode interface layer 570, an anode 520 having a copper or nickel current collector and an anode interface layer 580. A solid ionic conductor or porous electrolyte structure 530 is situated between the cathode interface layer 570 and the anode interface layer 580. The porous electrolyte structure 530 is prepared from a porous ceramic material and has an interconnected ceramic matrix 545 with a network of open pores 540 extending from the surface and disposed throughout the thickness of the electrolyte structure 530. An intermetallic layer 535 is disposed on the ceramic matrix 545. As shown in FIGS. 3A and 3B. the intermetallic layer 535 is disposed on a portion of the ceramic matrix 545. The intermetallic layer 535 contacts the anode interface layer 580 and is electrically connected to the anode 520. The intermetallic layer 535 extends along the ceramic matrix 545, but does not fully extend to contact the cathode interface layer 570 and the intermetallic layer 535 is not electrically connected to the cathode 510. In another preferred embodiment, there is no anode interface layer 580 and the intermetallic layer 535 contacts the anode 520 and is electrically connected to the anode 520. In the charged state, ions, such as lithium or sodium ions, move toward the anode and are reduced and deposit as metal 550 on the anode 520 and into the open pore spaces 540 in the porous electrolyte structure 530, which minimizes the overall volume change of the charged battery. The reduced volume change in the battery cell between the charged and discharged states eliminates stress from concentration change and reduces dendrite formation.

The intermetallic layer may have a uniform thickness or it may have a non-uniform thickness that can vary in its application or disposition on the electrolyte structure. The intermetallic layer or film may be very thin. In some embodiments the average thickness of the intermetallic layer is <1 micron. In other embodiments the average thickness of the intermetallic layer is in the range of about 10 nm to about 100 nm. In another embodiment, the average thickness of the intermetallic layer is in a range of about 30 nm to about 80 nm. In another embodiment, the intermetallic layer thickness varies from about 30 nm to about 80 nm. The thin intermetallic layer or film minimizes any volume expansion that occurs in alloying or other interaction process with lithium metal between charging and discharging and maintains the integrity of the intermetallic layer or film.

As the metal ions move toward the anode, lithium ions are attracted to the metallic alloving elements in the intermetallic layer. Some of the lithium ions come into contact with the intermetallic layer and may form lithium metal alloys with the metallic alloying elements. An intermetallic phase can be formed on the surface of the intermetallic layer. The intermetallic phase may include lithium metal alloys, lithium metal ions, conductive particles, such as carbon, and one or more metallic elements, such as non-lithium-alloying metals.

Without being bound by a particular theory, it is believed that Lithium dendrite formation is mitigated both by the porous structure of the electrolyte and the intermetallic layer. The porous electrolyte structure has a high surface area and a low local current density and provides a low energy alternative path for lithium growth into the open pore volume. The intermetallic layer wets the oxide electrolyte and the Li metal is attracted to the surface of the intermetallic layer, which stabilizes the interface between lithium metal and the intermetallic layer relative to a Li-vacuum interface. Since the Li-intermetallic layer interface is stabilized, a voltage penalty is incurred to remove lithium metal from the intermetallic layer during discharge, which maintains the lithium metal between cycles. Due to its wetting nature the intermetallic layer acts as a morphogen, directing the formation of the growing metallic Li phase, catalyzing the formation of lithium nucleation sites. and outcompeting growth on bare oxide surfaces. The intermetallic layer directs the growth of the lithium during charging. improving the electrical contact between the anode and the electrolyte material, and mitigates void formation in the lithium during discharge.

The effect of the stabilization of the Li metal-metallic layer interface relative to a Li-vacuum interface is that a free energy gradient for lithium metal vacancies is set up, such that during discharge vacancies will tend to drift away from the Li metal-intermetallic layer interface. Lithium metal vacancies are the precursors to void formation. During charging, Li+ flux is largest to areas of high growth and growth on the bare oxide electrolyte is unfavorable. The intermetallic layer on the surface of the electrolyte allows the lithium to spread over a larger area.

Further destabilization of voids at the lithium metal and metallic layer interface can occur when the intermetallic layer contributes desired dopants to the Li metal that is plated or deposited during charging. These desired dopants increase the mobility of Li-vacancies through grain boundary or vacancy formation, which enhances the vacancy flux away from the interface.

In another aspect, a solid state battery cell includes a cathode, an anode and a porous electrolyte structure disposed between the cathode and the anode and an intermetallic layer disposed on the porous electrolyte structure. The porous electrolyte structure having a thickness and an interconnected ceramic matrix with a network of open pores disposed throughout the thickness of the porous electrolyte structure. The porous electrolyte structure includes a porosity of about 10% by volume to about 80% by volume.

In one aspect, the solid state battery cell includes a cathode or positive electrode including a metal or metal alloy current collector and a cathode metal ion-conducting material, such as a cathode lithium ion-conducting material or cathode sodium ion-conducting material. Wires can be attached to the current collector to provide a path for electron flow from an external circuit. In one aspect, the current collector is a conducting metal or metal alloy. In another aspect, the current collector is aluminum. In one aspect, the current collector has a thickness of about 10 micrometers to about 20 micrometers.

In one aspect, the cathode material includes, but is not limited to LiTiS₂; LiCoO₂; LiNiO₂; LiMnO₂; LiNi_{0.33}Mn_{0.33}Co_{0.33}O₂; LiNi_{0.8}Co_{0.15}Al_{0.05}O₂, LiNi_{0.8}Co_{0.1}Mn_{0.1}O₂, Li₂MnO₃; LiMn₂O₄; LiCo₂O₄; LiFePO₄; LiMnPO₄; LiCoPO₄; LiFeSO₄F; Li₂O, LiVPO₄F; FeF₂; FeF₃; CoF₂; CuF₂; NiF₂; BiF₃; FeCl₃; FeCl₂; CoCl₂; NiCl₂; CuCl₂; AgCl; LiCl; S; Li₂S; Se; Li₂Se; Te; I; LiI, and combinations thereof. In another aspect.

the cathode is lithium metal oxide or a lithium iron phosphate infiltrated with liquid electrolyte, gel, or solid electrolyte, or combination thereof.

In another aspect, the cathode contains additives, such as carbon to increase electrical conductivity. In another aspect, the cathode contains binder materials. In another aspect, the cathode is coated on the current collector.

In one aspect, the cathode material has a thickness of about 50 micrometers to about 100 micrometers. In one aspect, the cathode may have a thickness of about 60 micrometers to about 120 micrometers.

In one aspect, the solid state battery cell includes an anode or negative electrode including a metal or metal alloy current collector. In one aspect, the anode may include a current collector coated with a metal, such as lithium metal or sodium metal. Wires can be attached to the current collector to provide a path for electron flow from an external circuit. In one aspect, the current collector is a conducting metal or metal alloy. In another aspect, the current collector is copper or nickel. In one aspect, the current collector has a thickness of about 10 micrometers. In one embodiment, the solid state battery is a lithium solid state battery.

In one aspect, the solid state battery cell includes a solid state electrolyte interface layer between the electrode and the porous electrolyte structure. A solid state electrolyte interface layer disposed between an electrode and electrolyte helps to improve the contact between the electrode (cathode or anode) and the porous electrolyte structure. In one aspect, the battery cell includes a cathode interface layer between the cathode and the porous electrolyte structure. In another aspect, the battery cell includes an anode interface layer between the anode and the porous electrolyte structure.

The interface layers can improve the contact between the porous electrolyte structure and the current collector. They can be ionically conductive, electrically conductive or both. They may be prepared from any conventional material used for making interface layers. In one aspect, the interface layers may be solid polymer electrolyte, including polyethylene oxide with bis(trifluoromethylsulfonyl)amine lithium salt (PEO/LiTFSi) or a combination of other lithium salt compounds, or a sulfide electrolyte, such as silver sulfide. In one aspect, the interface layer may be a membrane. In another aspect, the interface layer may be a lithophilic coating, such as aluminum oxide. In yet another aspect, the interface layer may be formed from a polymer gel electrolyte. In one aspect, the interface layer may be applied by atomic layer deposition. In one aspect, the porous electrolyte structure may interpenetrate into the interface layers.

In one aspect, the interface layer may have a thickness of about 10 nm to about 170 micrometers. In another aspect, the interface layer may be a coating having a thickness from about 10 nm to about 100 nm. In another aspect, the interface layer has a thickness from about 150 micrometers to about 170 micrometers.

In one aspect, additional metal, such as sodium or lithium may be added to the solid state battery cell during manufacture and prior to operation to provide the battery cell with more metal than can be provided by the cathode material. In one aspect, additional metal can be placed between the anode current collector and the porous electrolyte structure. In another aspect, the additional metal can be placed between the anode current collector and an anode interface layer. In these aspects. during battery cycling, erosion of the additional metal can also occur moving the metal into the porous electrolyte structure.

In another aspect, the additional metal can be placed between the cathode and the porous electrolyte structure. In another aspect, the additional metal can be placed between the cathode and a cathode interface layer. In these aspects, during battery cycling, the additional metal can also move into the open pores of the porous electrolyte structure or to a position between the porous electrolyte structure and the anode or into either position.

In one aspect, a porous electrolyte structure for a solid state battery is provided. The porous electrolyte structure includes an intermetallic layer disposed on a surface and having a thickness and an interconnected ceramic matrix with a network of open pores disposed throughout the thickness of the porous electrolyte structure. The porous electrolyte structure including a porosity of about 10% by volume to about 80% by volume.

An intermetallic layer is applied or disposed on the porous electrolyte structure by any customary manner. In one method, elements that comprise the metallic coating may be deposited via melt infiltration, electrochemical deposition or gas phase methods, such as physical vapor deposition (PVD), chemical vapor deposition (CVD) or atomic layer deposition (ALD). The elements may be deposited either upon precursor particles that are then processed into the porous ceramic component, or the porous ceramic part is infiltrated with metal using CVD or ALD after sintering.

In one aspect, a method for producing a solid state battery cell is provided. The method includes forming a porous electrolyte structure having a thickness and an interconnected ceramic matrix with a network of open pores disposed throughout the thickness of the porous electrolyte structure. applying an intermetallic layer on a surface of the porous electrolyte structure and inserting the porous electrolyte structure between an anode and a cathode. The porous electrolyte structure includes a porosity of about 10% by volume to about 80% by volume, based on the volume of the porous electrolyte structure.

The porous electrolyte may be manufactured together with the solid state battery cell, rather than in a separate process. Manufacturing the porous electrolyte with the solid state battery cell allows the porous electrolyte to be thinner and reduces the manufacturing costs of the battery cell. In some embodiments, battery performance is enhanced if the porous electrolyte is heated during battery fabrication. While not being bound by theory, this improvement can be due to the volatilization of impurities and/or the enhancement of particle connections.

In one aspect, the electrolyte material, such as ceramic electrolyte material, is applied to the anode, such as a copper or nickel foil. In another aspect, the electrolyte material is coated on the anode or anode interface layer. In another aspect, the electrolyte material is applied to the anode as a slurry with a solvent. In another aspect, the electrolyte material is heat treated. In another aspect, the electrolyte material is heat treated from about 850° C. to about 1200° C. In another aspect, the electrolyte material is heat treated for a time and temperature effective to cure the electrolyte material. In one embodiment, the electrolyte material may be heat treated at 850° C. for about 2 hours. In another embodiment, the electrolyte material may be heat treated or sintered with a high-rate heat treatment.

A high-rate heat treatment can be advantageous in reducing cost by reducing manufacturing time. A high-rate heat treatment can also be advantageous in locking in a desired porous electrolyte structure by minimizing the time during which components of the porous electrolyte can deform or move during a high temperature fabrication step. In one embodiment, the electrolyte material, such as ceramic electrolyte material, is heated with resistance heating by supplying a current through a resistance heating element. In another embodiment, the electrolyte material is heat treated by contacting or in close proximity to a resistance heating element, such as an alumina-coated tungsten strip. Resistance heating may include one or more resistive heating elements. In one embodiment, the electrolyte material is heated from about 10 seconds to about 5 minutes. In another embodiment, the electrolyte material may be heated from about 15 seconds to about 5 minutes. In another embodiment, the electrolyte material may be heated from about 20 seconds to about 3 minutes. In another embodiment, the electrolyte material may be heated from about 30 seconds to about 2 minutes. In another embodiment, the electrolyte material may be heated from about 30 seconds to about 1 minute. In one embodiment, the high-rate heat treatment is at a temperature of at least 800° C. In another embodiment, the temperature for the high-rate heat treatment is from about 1000° C. to about 3000° C. In another embodiment, the temperature for the high-rate heat treatment is from about 1000° C. to about 2000° C. In another embodiment, the electrolyte may be heat treated from about 800° C. to about 1350° C. In one embodiment, the electrolyte material may be heated to 1200° C. for about 30 seconds.

In some embodiments, pore sizes and connectivity of the pores may be controlled within the electrolyte structure. In some embodiments, pore sizes may be formed in the electrolyte structure by including pore-forming materials or other sacrificial materials in the preparation of the electrolyte structure. For example, pore-forming materials can be added to porous electrolyte precursor coating material. Examples of pore-forming materials include organic molecules, oligomers, polymers and copolymers, such as, but not limited to cellulose, ethyl cellulose, polystyrene, polycarbonate, polyacrylates, polymethacrylates, such as polymethyl methacrylate (PMMA), polyurethane, polyetherether ketone, polysulfones, poly(vinyl alcohol), poly(1,2-butylene glycol), polyethyleneglycol, poly(styrene-co-divinylbenezene), and mixtures thereof. The pore-forming materials can be incorporated into the electrolyte material in any form or shape, such as, but not limited to dissolved solutions, extruded mixtures, ground mixtures, hot-melt mixtures, particles, and fibers.

In another embodiment, the pore-forming material may be included in an amount of from about 1 to about 50 weight percent of the electrolyte material. During the manufacture of the electrolyte structure, the electrolyte material is heated to a temperature sufficient to volatilize the pore-forming material forming a porous electrolyte structure. In some embodiments, the electrolyte material is heated to a temperature in a range from about 250° C. to about 800° C. The electrolyte material may be heated from about 500° C. to about 800° C. In another embodiment, the electrolyte may be heated in a range from about 500° C. to about 700° C. In other embodiments, the electrolyte material may be heated from about 250° C. to about 600° C. The electrolyte material may be heated for a time sufficient to volatize the pore-forming materials. In one embodiment, the electrolyte material is heated from about 1 to about 3 hours. In another embodiment, the electrolyte material may be heated for about 1 to about 2 hours. In one embodiment, the electrolyte with pore-forming material may be heated to about 600° C. for about 2 hours to volatilize the pore-forming material before the electrolyte material is sintered to form a ceramic electrolyte material.

An intermetallic layer is applied or disposed on the ceramic matrix of the porous electrolyte structure in any conventional manner. In one method, elements that comprise the metallic coating may be deposited via melt infiltration, electrochemical deposition or gas phase methods, such as physical vapor deposition (PVD), chemical vapor deposition (CVD) or atomic layer deposition (ALD). The elements may be deposited either upon precursor particles that are then processed into the porous ceramic component, or the porous ceramic part is infiltrated with metal using CVD or ALD after sintering.

In another embodiment, a method to form the intermetallic layer includes mixing an oxide precursor with a Li-ion conductive ceramic material and exposing the mixture to a reducing atmosphere to convert the metal oxide. The metal oxide must be reduced prior to a significant reduction of the Li-ion transporting ceramic. BiO, Cu₂O and NiO are suitable metal oxides, as these oxides are less stable relative to the reduced metal than many other metal oxide materials. The reduction process can be done as a separate step or can occur during a sintering process of the ceramic electrolyte. The resultant intermetallic layer can be used as a seed or templating layer for additional metal deposition to form the intermetallic layer.

In another embodiment, the intermetallic layer is formed by creating a seed layer of metal nanoparticles on the surface of the ceramic via exsolution of the metal from the ceramic electrolyte. Following the methodology given in Qi. et. al. [Reversible In-situ exsolution of Fe catalyst in La0.5Sr1.5Fe1.5Mo0.5O6-δ anode for SOFCs, ECS Transactions, 91 (1) 1701-1710 (2019)], a precursor oxide in which the metal ions are intimately mixed is prepared via co-precipitation of the metal and metal oxide salts in an aqueous solution. Following calcination under an oxidizing atmosphere, the material is then exposed to a reducing atmosphere at a high temperature (for example, hydrogen gas at about 1100K), which results in the reduction of metal ions as nanoparticles on the surface of the ceramic.

In another embodiment, electroless plating can be used to deposit metals on the surface of the ceramic electrolyte. The plated material can either be used as a precursor for the Li-alloy layer on the ceramic electrolyte, or a seed layer that promotes the selective deposition of metals to form the intermetallic layer. In one embodiment, silver is deposited on the surface of the ceramic electrolyte by electroless plating. The surface of the ceramic electrolyte is sensitized with Stannous Chloride (SnCl₂) followed by treatment with Tollens' reagent.

In another embodiment, melt infiltration is used to coat the porous ceramic electrolyte. In this method, a metal or metal alloy is placed adjacent to the porous ceramic electrolyte and then both are heated to above the melting point of the metal or metal alloy. The molten metal then infiltrates the pores via capillary action. The infiltration may be promoted in some cases by the addition of a wetting layer on some sections of the porous electrolyte. In some embodiments the metal or metal alloy is first deposited on the anode surface. followed by deposition of the porous ceramic. The anode-metal alloy-ceramic structure is then heated to above the melting point of the metal.

One method to create the porous solid state electrolyte structure that includes a coated section and a non-coated section present in some embodiments is to create a porous ceramic layer via successive deposition of particle precursors. Layer deposition methods include spray coating or deposition from a slurry spread to a defined thickness via a doctor blade. Between each deposition step the ceramic material may be subject to one or more heat or metallization treatments. Alternatively, the composition of the particles can be varied between the different layers, so that, for example, some layers will exsolute precursor nanoparticles that direct the subsequent growth of the intermetallic layer on the porous ceramic or precursor particles are coated with a metal coating prior to partial sintering.

In one embodiment, a gradient structure is prepared by applying or depositing a metal film or coating throughout the thickness of the porous ceramic structure. The metal film is subsequently chemically etched on one side. The sections of the metal film that are most exposed to the etchant will preferentially etch prior to those areas that are further away. The etchant can be introduced either as gas or in a liquid phase.

Selective masking can be used to control the location of the metal coating within the porous ceramic electrolyte. In this method, a sacrificial coating is applied to one side of the porous ceramic electrolyte and a subsequent coating of the metal or a seed layer for the metal is applied. In a subsequent step the sacrificial layer is then removed.

In one embodiment, CVD can be used to deposit a graded intermetallic layer throughout the porous electrolyte structure. Metallic elements are deposited on the surface of the interconnected ceramic electrolyte structure. The CVD process will deposit higher concentrations of the metallic elements at the top portion of the porous electrolyte structure with decreasing amounts of the metallic elements that are farther from the top portion, such that a middle portion of the porous electrolyte structure will have a thinner intermetallic layer or coating than the top portion of the porous electrolyte structure and the bottom portion of the porous electrolyte structure will have a thinner intermetallic layer or coating than the middle or top portions of the porous electrolyte structure. In some embodiments, the bottom portion of the porous electrolyte structure will have no intermetallic layer or coating.

In another aspect, the solid ceramic electrolyte structure includes a porous portion and a dense portion. An intermetallic layer is at least partially disposed on the porous portion of the solid electrolyte structure. In one aspect, the porous portion is disposed between the anode and the dense portion of the solid electrolyte. The porous portion has an interconnected ceramic matrix with a network of pores disposed throughout the porous portion as described above and may be configured to hold anode material within the pores when the battery cell is in a charged state. In one aspect, the porous portion includes a porosity of about 80% by volume to about 100% by volume. In another aspect. the porous portion includes a porosity of about 80% by volume to about 95% by volume. In another aspect, the porous portion includes a porosity of about 80% by volume to about 90% by volume.

In one aspect, the battery cell may be assembled by applying a cathode to a porous electrolyte, such that the electrolyte is between the cathode and anode and contacts the cathode and anode and partially applying or depositing an intermetallic layer to the porous electrolyte, such that the intermetallic coating contacts the anode, but does not contact the cathode. In one aspect, additional layers may be included in the battery cell. In one aspect, the battery cell may include a cathode interface layer, which is sandwiched between the cathode and porous electrolyte structure during the battery cell assembly. In another aspect, the battery cell includes an anode interface layer, which is sandwiched between the anode and the porous electrolyte structure during the battery cell assembly.

### EXAMPLES

### Example 1

A porous electrolyte structure was prepared by mixing LLZO powder with pore formers and solvent. The electrolyte material was heat treated at lower temperatures, 250° C. to 600° C., to volatilize the pore formers. Subsequently, the electrolyte material was sintered at higher temperatures, 800° C. to 1350° C. The resulting electrolyte structure had an interconnected LLZO ceramic matrix with a network of open pores dispersed throughout the electrolyte structure. The porosity of the resulted electrolyte was greater than 20% and up to 70%.

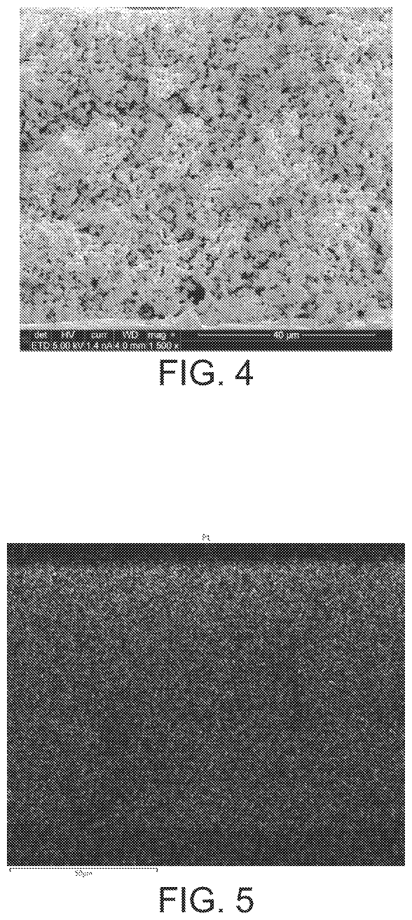

A thin layer of platinum was deposited on the porous electrolyte structure by CVD. The thickness of the platinum coating ranged from 30 nm to 80 nm. An image from a scanning electron microscope (SEM) of a fracture of the coated porous electrolyte structure is shown in FIG. 4. The SEM image shows a coated and interconnected LLZO ceramic matrix with a network of open pores.

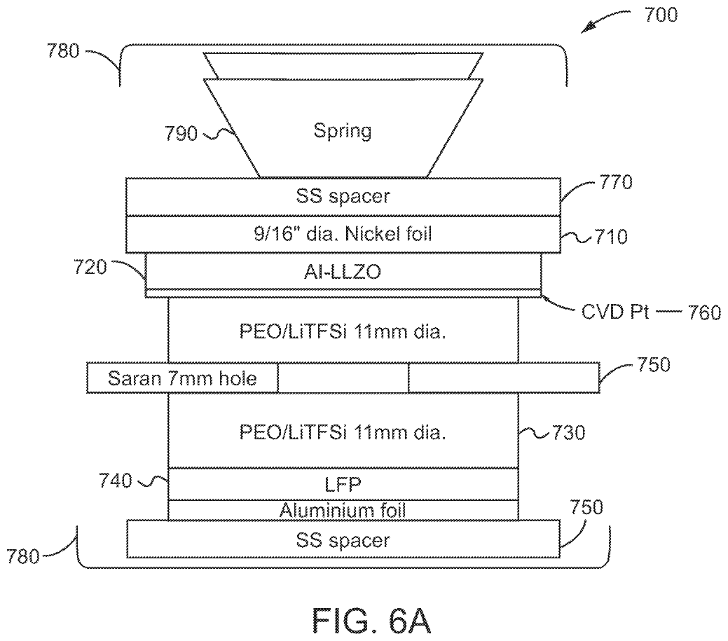

The CVD process deposits a first order layer of platinum on the porous electrolyte structure consistent with a monotonically decreasing function away from the surface. The concentration of platinum deposited is highest at the surface or top portion of the electrolyte structure and decreases as the platinum coating is deposited farther from the surface or top portion of the electrolyte section. FIG. 5 provides an Energy Dispersive X-Ray Spectroscopic (EDX) map of the platinum coating in a thickness of the LLZO electrolyte structure. The map in FIG. 5 shows a graded distribution of the platinum coating on the electrolyte structure with a higher concentration of platinum at the top portion of the and decreasing amounts as the platinum is deposited farther from the top portion of the electrolyte structure.

### Example 2

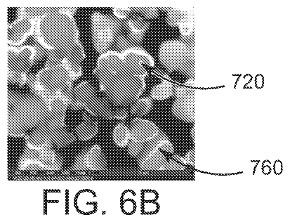

Two exemplary coin cell assemblies were prepared. The coin cell assembly 700 is shown in FIG. 6A. The coin cell includes an anode 710, a porous electrolyte structure 720, a cathode interface layer 730 and a cathode 740. The anode 710 is a nickel foil having a 9/16″ diameter and the cathode 740 is an aluminum foil coated with LiFePO₄ (LFP). The porous electrolyte structure 720 contacts the anode 710 and is sandwiched between the anode 710 and a cathode interface layer 730, which contacts the cathode 740. The cathode interface layer 730 is a poly(ethylene oxide)-lithium bis(trifluoromethanesulfonyl)imide (PEO/LiTFSi) polymer electrolyte having a diameter of 11 mm. The cathode interface layer 730 includes a SARAN separator 750 with a 7 mm hole.

The porous electrolyte structure 720 is an aluminum doped lithium lanthanum zirconate oxide (Al-LLZO) material. The porous electrolyte structure 720 was prepared by combining Al-LLZO powder with pore formers and heating the materials to cure the Al-LLZO compound and volatilize the pore formers. The resulting electrolyte structure had an interconnected ceramic matrix with a network of open pores dispersed throughout the electrolyte structure. A thin layer of platinum 760 was deposited on the porous electrolyte structure 720 by CVD in a graded distribution with higher concentrations of the platinum at the surface of the structure and lower concentrations farther from the surface of the structure. FIG. 6B shows an SEM image of a close-up view of the porous electrolyte structure 720 coated with a thin layer of platinum 760. The average thickness of the platinum coating was 35 nm. A layer of platinum was also deposited on the top portion of the LLZO electrolyte. The coin cell 700 was assembled such that the top portion of the electrolyte structure 720 with higher amounts of deposited platinum 760 contacted the PEO based electrolyte and the bottom portion with reduced levels of platinum contacted the anode 710. Prior to assembly, the portion of the coated LLZO distal to the solid metallic anode was abraded to remove the top layer of platinum coating.

The coin cell layers were assembled between two stainless steel spacers 770 and loaded into a button casing 780 with a spring 790. The coin cell 700 was charged with 5 micrometers of lithium.

A control cell battery was also assembled as shown in FIG. 6A, but the control cell battery did not include a platinum coating 760 deposited on the porous electrolyte structure 720.

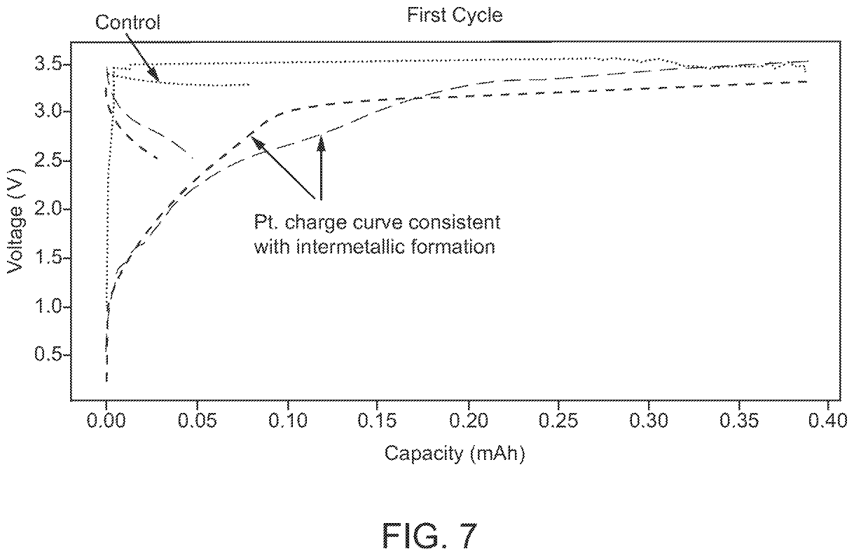

The first cycle charge curve for the coin cells is shown in FIG. 7. The charging curves for the exemplary coin cells indicate intermetallic formation between lithium and the platinum coating. It is believed that the platinum-coated onto the Al-LLZO ceramic structure operates as a porous anode in the cell. The lithium ions are attracted to the platinum coating and can react to form a lithium platinum compound, such as Li₄Pt or Li₉Pt, on the platinum coating surface.

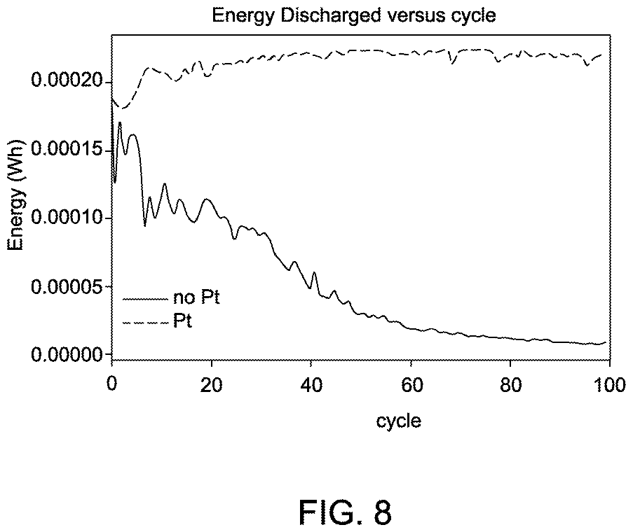

FIG. 8 shows a graph of the amount of energy discharged from both the exemplary coin cell (Pt) and the control cell (no Pt) when each is charged using a similar charging protocol. As the control cell is cycled further its ability to store charge and energy is degraded. This degradation limits the amount of energy that can be extracted on discharge. The exemplary coin cell does not exhibit this degradation effect over the first 100 cycles of operation.

This written description uses examples to explain the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A porous electrolyte structure for a solid state battery, the porous electrolyte structure comprising an intermetallic layer disposed on a surface and having a thickness and an interconnected ceramic matrix with a network of open pores disposed throughout the thickness of the porous electrolyte structure, wherein the porous electrolyte structure comprises a porosity of about 10% by volume to about 80% by volume.

2. The porous electrolyte structure of claim 1, wherein the ceramic matrix is lithium lanthanum zirconium oxide.

3. The porous electrolyte structure of claim 1, wherein the intermetallic layer comprises a lithium metal alloy.

4. The porous electrolyte structure of claim 1, wherein the intermetallic layer comprises a lithium platinum compound and optionally, comprises one or more of conductive particles or non-lithium-alloying metals.

5. The porous electrolyte structure of claim 1, wherein the intermetallic layer is disposed on about 25 percent to about 75 percent of the total extent of the electrolyte structure.

6. The porous electrolyte structure of claim 1, wherein an intermetallic phase is formed on a surface of the intermetallic layer.

7. A solid state battery cell comprising a porous electrolyte structure and an intermetallic layer disposed on the porous electrolyte structure, wherein the porous electrolyte structure has a thickness and an interconnected ceramic matrix with a network of open pores disposed throughout the thickness of the porous electrolyte structure and a porosity of about 10% by volume to about 80% by volume.

8. The solid state battery cell of claim 7, wherein the ceramic matrix is lithium lanthanum zirconium oxide.

9. The solid state battery cell of claim 7, wherein the intermetallic layer comprises a lithium metal alloy.

10. The solid state battery cell of claim 9, wherein the lithium metal alloy comprises lithium and an alloying element selected from the group consisting of aluminum, antimony, bismuth, gallium, germanium, indium, tin, magnesium, silicon, silver, gold, platinum, zinc, and combinations thereof.

11. The solid state battery cell of claim 7, wherein the intermetallic layer comprises a lithium platinum compound.

12. The solid state battery cell of claim 11, wherein the intermetallic layer further comprises conductive particles, non-lithium-alloying metals, or a mixture thereof.

13. The solid state battery cell of claim 7, wherein the intermetallic layer is disposed on about 25 percent to about 75 percent of the total extent of the electrolyte structure.

14. The solid state battery cell of claim 7, wherein an intermetallic phase is formed on a surface of the intermetallic layer.

15. The solid state battery cell of claim 14, wherein the intermetallic phase comprises lithium metal alloys and lithium metal ions.

16. The solid state battery cell of claim 15, wherein the intermetallic phase further comprises conductive particles, non-lithium-alloying metals, or a mixture thereof.

17. The solid state battery cell of claim 7, wherein one or more of the open pores are at least partially filled with lithium ions.

18. A solid state battery cell comprising a cathode, an anode and a porous electrolyte structure disposed between the cathode and the anode and an intermetallic layer disposed on the porous electrolyte structure, the porous electrolyte structure having a thickness and an interconnected ceramic matrix with a network of open pores disposed throughout the thickness of the porous electrolyte structure, wherein the porous electrolyte structure comprises a porosity of about 10% by volume to about 80% by volume.

19. The solid state battery cell of claim 18, wherein the intermetallic layer is a coating and is disposed on a portion of the interconnected ceramic matrix such that the porous electrolyte structure comprises a coated section and a non-coated section, and wherein the coated section of the electrolyte structure is situated adjacent the anode and the non-coated section is situated adjacent the cathode.

20. The solid state battery cell of claim 18 further comprising (1) a cathode interface layer disposed between the cathode and the porous electrolyte structure, (2) an anode interface layer disposed between the anode and the porous electrolyte structure, or (3) a cathode interface layer and an anode interface layer, wherein the cathode interface layer is disposed between the cathode and the porous electrolyte structure and the anode interface layer is disposed between the anode and the porous electrolyte structure.

21-30. (canceled)
